(19) United States
(12) Patent Application Publication
(10) Pub. No.: US 2020/0017066 A1
(43) Pub. Date: Jan. 16, 2020

(54) CHILD SEAT WARNING SYSTEM

(71) Applicant: TOYOTA MOTOR EUROPE, Brussels (BE)

(72) Inventors: Venu Gopal GORU, Brussels (BE); Etienne LEQUELLEC, Brussels (BE); François RENAUDIN, Cholet (FR)

(73) Assignee: Toyota Motor Europe, Brussels (BE)

(21) Appl. No.: 16/489,499

(22) PCT Filed: Feb. 28, 2017
(86) PCT No.: PCT/IB2017/000357

§ 371 Date: Aug. 28, 2019

(51) Int. Cl. B60R 22/48; B60N 2/28; B60N 2/00; B60N 2/90

(52) U.S. Cl. CPC B60R 22/48; B60N 2/28; B60N 2/002; B60N 2002/981; B60R 2022/4866; B60R 2022/4808; B60R 2022/4858; B60N 2/90

(57) ABSTRACT

A child seat misuse warning system for a vehicle, comprising a child seat having one or more misuse sensors embedded in the child seat, the one or more misuse sensors being configured to obtain data regarding a state of installation of the child seat; and transmission means configured to transmit data obtained by the misuse sensors to a vehicle; a terminal configured to be embedded in a vehicle and to receive data transmitted by the transmission means, the terminal comprising display means configured to display signals to a user; the child seat being communicatively connected to the terminal; wherein the child seat warning system is configured to, on the basis of the data obtained by the misuse sensors and received by the terminal, display a signal with the display means indicating whether the installation of the child seat is in a misuse state.

### FIELD OF THE DISCLOSURE

The present disclosure is related to child seats for vehicle, and more particularly to systems and methods for warning of improper child seat installation.

### BACKGROUND OF THE DISCLOSURE

Improper installation of child seats in a vehicle and misuse while securing the child is a common issue existing with current child-seats in the market. The occupant of the vehicle, such as the driver, should be warned of improper installation of the child seat, so as to ensure the security of the child seated in the child seat. Various systems exist for detecting such improper installations and warning the drivers of vehicles accordingly.

EP 1 819 554 B1 discloses a safety system for a vehicle comprising a first acquisition unit for acquiring first information relating to a child seat placed on a seat of a vehicle, a second acquisition unit for acquiring second information relating to the child seat, and a controller capable of evaluating first information and second information individually and a combination of first and second information for detecting misuse of the child seat and for generating a misuse signal indicative of the misuse.

JP 2005-271768 discloses a child seat attachment defective alarm system capable of alarming and informing an occupant when an attachment state of the child seat is not proper.

JP 2015-128915 discloses a rear seat occupant monitor system capable of confirming the behavior of a rear seat occupant without any cost increase.

### SUMMARY OF THE DISCLOSURE

In the configurations described in the above prior art, only the sensors on the vehicle (seat belt buckle sensor, pressure sensor, seat belt tension sensor . . . ) allow detecting issues with the child-seat installation. However, such configurations do not allow optimizing the efficiency of child-seat misuse warning, and thus the safety of the child. Therefore, it remains desirable to provide a child seat misuse warning system that can improve safety.

According to embodiments of the present disclosure, a child seat misuse warning system for a vehicle is provided. The system includes a child seat having: one or more misuse sensors embedded in the child seat, the one or more misuse sensors being configured to obtain data regarding a state of installation of the child seat; and transmission means configured to transmit data obtained by the misuse sensors to a vehicle. The system also includes a terminal configured to be embedded in a vehicle and to receive data transmitted by the transmission means, the terminal comprising display means configured to display signals to a user. The child seat is communicatively connected to the terminal. The child seat warning system is configured to, on the basis of the data obtained by the misuse sensors and received by the terminal, display a signal with the display means indicating whether the installation of the child seat is in a misuse state.

By providing such a system according to embodiments of the present disclosure, a driver can be informed of current installation state of a child in the child seat (e.g. misuse or proper installation) and take necessary measures when the child seat is improperly installed. Indeed, since the child seat itself includes the sensors for detecting a state of installation of the child seat, and the child seat is communicatively connected to the vehicle, more accurate information about the state of installation of the child seat can be given to the user.

The plurality of misuse sensors may comprise at least one of a child presence sensor configured to detect whether a child is present in the child seat, a child seat buckle sensor configured to detect whether the child seat buckle is latched, or a child seat attachment sensor configured to detect whether the child seat is attached to the vehicle.

The terminal may comprise receiving means configured to receive data transmitted by the transmission means, and processing means to process communication between the receiving means and the displays means.

The child seat misuse warning system may further comprise a plurality of vehicle state sensors configured to be embedded on the vehicle, the processing means being configured to process communication between the plurality of vehicle state sensors and the display means, and the display means being configured to display a signal indicating whether the installation of the child seat is in a misuse state, based on the data obtained by the misuse sensors and the vehicle state sensors.

The plurality of vehicle state sensors may be configured to determine whether the vehicle is parked.

The child seat may be communicatively connected to the terminal by one of a Bluetooth connection, wifi connection, or a wired connection.

According to embodiments of the present disclosure, when the installation of the child seat is in a misuse state and the vehicle is not parked, the child seat warning system is configured to display a signal in accordance with a drive time of the vehicle.

According to another embodiment of the present disclosure, a vehicle comprising the child seat misuse warning system as defined above is provided.

According to yet another embodiment of the present disclosure, a method for warning of child seat misuse is provided. The method includes obtaining data regarding an installation state of a child seat in a vehicle from misuse sensors embedded in said child seat, transmitting data obtained by the misuse sensors to a terminal embedded in the vehicle, displaying a signal indicating whether the child seat is in a misuse state, based on the data obtained by the misuse sensors.

By providing such a method, embodiments of the present disclosure may enable a driver to be efficiently informed of current installation state of a child in the child seat (e.g. misuse or right use) and take necessary measures in a case where the child seat is improperly installed.

The method may also include, when the child seat is in a misuse state, obtaining data regarding the state of the vehicle from vehicle sensors embedded in the vehicle, displaying a signal indicating that the child seat is in a misuse state, based on the data obtained by the vehicle sensors, and in accordance with a drive time of the vehicle.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1 shows an exemplary vehicle comprising a child seat misuse warning system according to embodiments of the present disclosure;

FIG. 2 is a diagram representing an detailed exemplary of the structure of the system according to FIG. 1;

FIG. 3 is a flowchart highlighting an exemplary method for warning of child seat misuse according to embodiments of the present disclosure.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

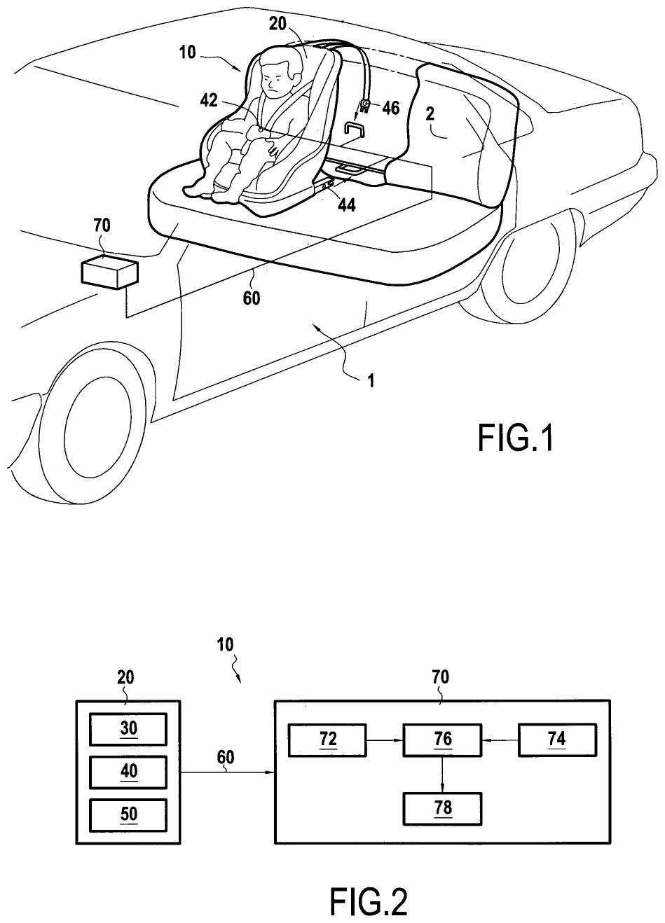

FIG. 1 shows an exemplary child seat misuse warning system 10 according to embodiments of the present disclosure. The child seat misuse warning system is included in a vehicle 1. The child seat misuse warning system 10 may include a child seat 20, a terminal 70, and a connection 60 connecting the child seat 10 to terminal 70. The child seat 20 may be installed in the back seat 2 of the vehicle 1, while the terminal 70 of the misuse warning system 10 may be installed at a front portion of the vehicle 1, under the dash board for example. The connection 60 may be a Bluetooth connection, a wifi connection, or a wired connection for example.

The child seat 20 may include a child presence sensor 30, which may be a weight sensor, a capacitance sensor or a pressure sensor for example, misuse sensors 40, and a transmission means 50, which may be a transmitter, and which is configured to transmit the data obtained by the child presence sensor 30 and the misuse sensors 40 to the terminal 70.

The misuse sensors 40 may include at least one of a child seat buckle sensor 42, which detects whether the buckle is latched, an ISOFIX sensor 44 (ISOFIX being also called LATCH for “Lower Anchors and Tethers for Children”, and is an international standard for attachment points for child safety seats in passenger cars, the attachment points being located between the seat back and the seat cushion of the vehicle), which detects whether the child seat is hooked to the ISOFIX, and a top tether sensor 46 (which is an attachment point located behind the seat back of the vehicle), which detects whether the child seat is hooked to the top tether.

The terminal 70 may include a receiving means 72, vehicle state sensors 74, a processing means 76 and a display means 78. The receiving means 72 may be a signal receiver configured to receive the data transmitted by the connection 60. The vehicle state sensors 74 may be embedded in the vehicle 1 and configured to determine whether the vehicle 1 is parked. The processing means 76 may be a vehicle electronic control unit (ECU), and may be configured to receive data from the receiving means 72 and the vehicle state sensors 74, and to process communication between the receiving means 72, the vehicle state sensors 74 and the display means 78. The display means 78 may be configured to display information provided by ECU 76 to a driver of vehicle 1, and may be a digital display unit or any suitable device for providing visible and/or audible information to a driver of vehicle 1, by displaying a visual and/or an audio signal on a screen (display screen) or on the dash board for example. The display means 78 indicates whether the installation of the child seat is in a misuse state, based on the data obtained by the misuse sensors 40 and the vehicle state sensors 74.

The ECU 76 may include any suitable device configured to manipulate data, perform calculations, execute code for decision making, and causing display of information to an operator of vehicle 1, in order to carry out embodiments of the present disclosure. For example ECU 10 may include various analog and/or digital circuits, and may include integrated circuits such as RISC processors, i386 processors, ASIC processors, etc. Typically, on-board computers in modern vehicles include such processors, and one of skill will understand that the present ECU 76 may be comprised by such an on-board computer, or may be separately provided. One of skill in the art will also understand that the exemplary systems described herein are not intended to be limiting, and that any suitable device may be implemented.

ECU 10 may be linked to one or more databases and/or other memory (e.g., RAM, ROM, etc.) associated with vehicle 1 so as to enable storage of vehicle related data as well as values that may be utilized during processing of vehicle functions (e.g., threshold values). One of skill in the art will recognize that information discussed herein with regard to any such databases and/or memory is not intended to be limiting.

ECU 76 may include one or more means for receiving the data from the receiving means 72 and the state information from one or more sensors 74. For example ECU 76 may be linked to one or more interfaces, e.g. network interfaces, which may be configured to receive wirelessly and/or by wire the state information, among others.

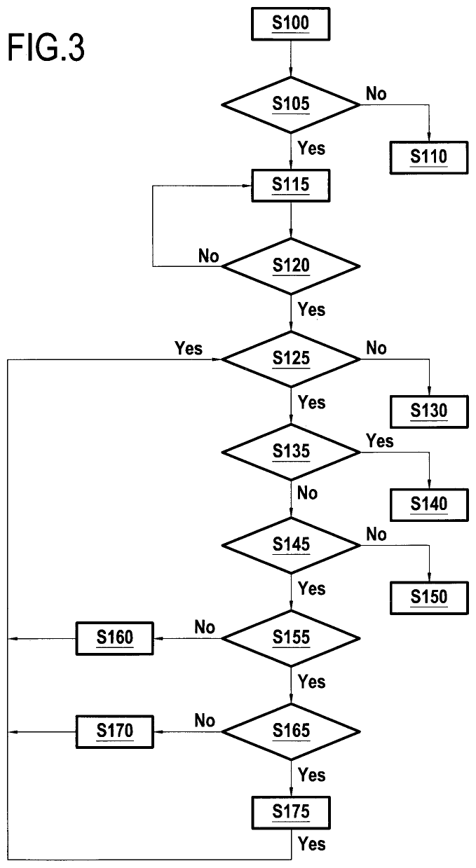

An exemplary method for warning of child seat misuse according to embodiments of the present disclosure will now be described on the basis of the flowchart illustrated in FIG. 3.

The child seat misuse warning system starts running when the vehicle power is turned on (step S100). At this time, the terminal 70 searches for a child seat 20, and determines whether a child seat 20 is present in the vehicle 1 (step S105). If it is determined that no child seat is present in the vehicle (step S105: No), the process ends (step S110). If it is determined that a child seat 20 is present in the vehicle (step S105: Yes), the terminal 70 establishes connection with the child seat 20, via the connection 60 (step S115). Then, the system verifies whether the child seat 20 has been successfully connected to the terminal 70 (step 120). If it is determined that the connection between the child seat 20 and the terminal 70 has not been successfully made (step 120: No), the process returns to step 115, in order to establish a connection between the terminal 70 with the child seat 20. On the other hand, if it is determined that the connection between the child seat 20 and the terminal 70 has been successfully made (step S120: Yes), the system determines whether the installation of the child seat 20 has been properly installed (step S125), through the data obtained by the misuse sensors 40. For example, if the child seat buckle sensor 42 detects that the buckle of the child seat is latched, this data is sent from the transmitter 50 to the signal receiver 72 of the terminal 70 via the connection 60, said data being then transmitted to the ECU 76 and the corresponding signal being displayed by the display means 78. The same applies when the ISOFIX sensor 44 detects that the ISOFIX is latched, or when the top tether sensor 46 detects that the top tether is hooked. Thus, when it is determined that no misuse is present (step S125: No), the display means 78 displays a message to the user, indicating that all is normal (step S130). For example, a message “All ok” is displayed on a screen. On the other hand, when one of the misuse sensors 40 detects that a misuse is present (step S125: Yes), a test is made on the vehicle state, by the vehicle state sensors 74, in order to determine whether the vehicle 1 is parked or is moving (step S135). If it is determined that the vehicle 1 is parked (step S135: Yes), the display means 78 displays a signal to the user indicating that a misuse is present (step S140). Such a signal aims to inform the user that the child seat 20 should be correctly installed and attached while the vehicle 1 is still parked, and before switching to the driving state.

On the other hand, when where the vehicle 1 is not parked (step S135: No), meaning that the vehicle 1 is moving, a test is made in order to determine whether a child is present in the child seat 20, by the child presence sensor 30 (step S145). The data obtained by the child presence sensor 30 is sent from the transmitter 50 to the signal receiver 72 of the terminal 70 via the connection 60, said data being then transmitted to the ECU 76 and the corresponding signal being displayed by the display means 78. Thus, when it is determined that no child is present in the child seat 20 (step S145: No), the display means 78 displays a signal to the user indicating that a misuse is present (step S150). Such a signal may be analogous to the signal displayed in step S140, when it is determined that the vehicle 1 is parked. Indeed, since no child is present in the child seat 20, no emergency is indicated, and this signal only aims to inform that the child seat should be correctly installed and attached.

On the other hand, if it is determined that a child is present in the child seat 20 (step S145: Yes), since the security of the child may be involved, the system is configured to warn the user that he should urgently stop the vehicle in order to correctly attached the child seat 20. In view of that, the type of warning displayed by the display means 78 may depend on a drive time elapsed since the determination of the presence of a child in step S145, during which the vehicle continues moving. To do that, the ECU 76 may be configured to calculate a drive time Td, which starts to run at the time when the presence of child in the child seat 20 is determined (step S145: Yes), and to compare said time Td to at least one threshold time. For example, a first threshold time may be set to 30 seconds, and a second threshold time may be set to 90 seconds. Thus, when the presence of a child is determined (step S145: Yes), the ECU 76 firstly compares the drive time Td to the first threshold time value. If Td is less than or equal to the first threshold, e.g. 30 seconds (step S155: No), the display means 78 displays a first warning signal (described in more details below) to the driver (step S160), and the process returns to step S125. If Td is greater than the first threshold (step 155: Yes), the process then compares Td to the second threshold (step S165). If Td is less than or equal to the second threshold, e.g. 90 seconds (step S165: No), the display means 78 displays a second warning signal (described in more details below) to the driver (step S170), and the process returns to step S125. If Td is greater than the second threshold (step S165: Yes), the display means 78 displays a third warning signal (described in more details below) to the driver (step S175), and the process returns to step S125.

The different types of warnings displayed by the display means 78 may be summarized on the table 1 below.

TABLE 1

| Warning | Drive | | |
|---|---|---|---|
| Type | Time | Signals | Details of Warning |
| Installation | — | Visual | 1) Partial screen pop-up on display |
| guide | | | 2) Misuse part highlighted (red) |
| | | | 3) Stays until user intervention |
| | | Audio | 1 beep |
| Low | 0 < t < 30 s | Visual1 | 1) Partial screen pop-up on display |
| | | | 2) Misuse part highlighted (red) |
| | | | 3) flash rate (1.2 s) |
| | | | 4) Stays until user intervention |
| | | Audio1 | Sound Level Low |
| High | 30 < t < 90 s | Visual2 | 1) Full screen pop-up on display |
| | | | 2) Misuse part highlighted (red) |
| | | | 3) flash rate (0.4 s) |
| | | | 4) Stays until user intervention |
| | | Audio 2 | Sound Level high |
| Final | t > 90 s | Visual3 | 1) Partial screen pop-up on display |
| | | | 2) Misuse part highlighted (red) |
| | | | 3) flash rate (1.2 s) |
| | | | 4) Stays until user intervention |
| | | Audio3 | No audio |

In a case where the vehicle 1 is parked, or where no child is present in the child seat 20, the display means 78 displays a signal to the user indicating that a misuse is present (steps S140 and S150). Such a signal may comprise a pop-up signal partially covering a surface of the display screen, while a “misuse indicator” (which may be a picture of any shape, for example an image of a child seat) on said screen is highlighted in red. Such a signal may also display an installation guide informing him which actions are necessary in order to correctly install and attach the child seat 20, and is maintained until the intervention of the user or, if the user does not intervene, until the next warning. This signal may also arise together with an audio signal, comprising a sound (for example one “beep”), in order to inform the user of a misuse state of the child seat 20, and to bring his attention to the display screen.

When the vehicle 1 is moving and a child is present in the child seat 20, the first warning signal (step S150) may be defined as a “low warning”, and arises in a case where a misuse of the child seat 20 is present and a child is in said child seat 20, when the drive time Td is less than a first threshold, e.g. 30 seconds, that is, when such a situation has just started to occur. Such a low warning may also consist in a pop-up signal partially covering a surface of the display screen, while the misuse indicator on said screen is highlighted in red and flashes to a predetermined rate, which may be of, for example, 1.2 seconds. This low warning is maintained until the intervention of the user or, if the user does not intervene, until the next warning. This low warning may arise together with an audio signal, comprising a low level sound, which comprises a sound fixed at a predetermined level.

The second warning signal (step S160) may be defined as a “high warning”, and arises in a case where a misuse of the child seat 20 is present and a child is in said child seat 20, when the drive time Td exceeds the first threshold, e.g. 30 seconds, and is less than the second threshold, e.g. 90 seconds, that is, when the user has not yet intervened since the low signal at the preceding step. Such a high warning may comprises a pop-up signal covering the whole surface of the display screen, while the misuse indicator on said screen is highlighted in red and flashes to a predetermined rate, for example higher than the predetermined rate for the low warning, which may be for example 0.4 seconds. This high warning is maintained until the intervention of the user or, if the user does not intervene, until the next warning. This high warning may arise together with an audio signal, consisting in a high level sound, which is a sound fixed at a predetermined level higher than the predetermined level for the low warning. This high warning aims to further bring the attention of the user, in a case where he has not paid attention to the low warning.

The third warning signal (step S165) may be defined as a “final warning”, and arises in a case where a misuse of the child seat 20 is present and a child is in said child seat 20, when the drive time Td is greater than, for example, 90 seconds, that is, when the user has still not yet intervened, in spite of the low and the high warnings at the preceding steps. Such a final warning may be of the same type as the low warning, except that no audio warning arises together with the visual warning. This final warning is maintained until the intervention of the user and aims to remind him that a misuse is still present, but without disturbing him when, for example, he has noticed that a misuse is present, but cannot intervene immediately for any number of reasons (for example, there is no possibility to immediately park the vehicle).

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A child seat misuse warning system for a vehicle, comprising:
a child seat having: one or more misuse sensors embedded in the child seat, the one or more misuse sensors being configured to obtain data regarding a state of installation of the child seat; and transmission means configured to transmit data obtained by the misuse sensors to a vehicle;
a terminal configured to be embedded in a vehicle and to receive data transmitted by the transmission means, the terminal comprising display means configured to display signals to a user;
the child seat being communicatively connected to the terminal;
wherein the child seat warning system is configured to, on the basis of the data obtained by the misuse sensors and received by the terminal, display a signal with the display means indicating whether the installation of the child seat is in a misuse state.

2. The child seat misuse warning system according to claim 1, wherein the plurality of misuse sensors comprises at least one of a child presence sensor configured to detect whether a child is present in the child seat, a child seat buckle sensor configured to detect whether the child seat buckle is latched, or a child seat attachment sensor configured to detect whether the child seat is attached to the vehicle.

3. The child seat misuse warning system according to claim 1, wherein the terminal comprises receiving means configured to receive data transmitted by the transmission means, and processing means to process communication between the receiving means and the displays means.

4. The child seat misuse warning system according to claim 1, further comprising a plurality of vehicle state sensors configured to be embedded on the vehicle, the processing means being configured to process communication between the plurality of vehicle state sensors and the display means, and the display means being configured to display a signal indicating whether the installation of the child seat is in a misuse state, based on the data obtained by the misuse sensors and the vehicle state sensors.

5. The child seat misuse warning system according to claim 4, wherein the plurality of vehicle state sensors is configured to determine whether the vehicle is parked.

6. The child seat misuse warning system according to claim 1, wherein the child seat is communicatively connected to the terminal by one of a Bluetooth connection, wifi connection, or a wired connection.

7. The child seat misuse warning system according to claim 5, wherein, when the installation of the child seat is in a misuse state and the vehicle is not parked, the child seat warning system is configured to display a signal in accordance with a drive time of the vehicle.

8. A vehicle comprising the child seat misuse warning system according to claim 1.

9. A method for warning of child seat misuse, comprising:
obtaining data regarding an installation state of a child seat in a vehicle from misuse sensors embedded in said child seat;
transmitting data obtained by the misuse sensors to a terminal embedded in the vehicle;
displaying a signal indicating whether the child seat is in a misuse state, based on the data obtained by the misuse sensors.

10. The method according to claim 9, comprising:
when the child seat is in a misuse state, obtaining data regarding the state of the vehicle from vehicle sensors embedded in the vehicle;
displaying a signal indicating that the child seat is in a misuse state, based on the data obtained by the vehicle sensors, sensors, and in accordance with a drive time of the vehicle.
